(19) United States
(12) Patent Application Publication
(10) Pub. No.: US 2006/0088782 A1
(43) Pub. Date: Apr. 27, 2006

(54) Method of preparing toner composition

(75) Inventors: Jun-young Lee, Seoul (KR); Sang-woo Kim, Seoul (KR); Kyung-yol Yon, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/247,149

(22) Filed: Oct. 12, 2005

(30) Foreign Application Priority Data
Oct. 22, 2004 (KR) 2004-84751

(51) Int. Cl. G03G 9/08

(52) U.S. Cl. 430/137.11; 430/137.15

(57) ABSTRACT

A method of preparing a toner composition includes mixing a colorant dispersion and a latex solution and coagulating to form the core of the toner particle; adding a polymerization initiator to the core; and adding a monomer to the core to form a shell of the toner particle through polymerization on the core surface. According to the present invention, a toner composition by which a shape of a toner may be readily embodied even with high durability, may be prepared by a toner having core/shell structures.

### CROSS-REFERENCE TO RELATED APPLICATIONS

This application claims the benefit under 35 U.S.C. §119 of Korean Patent Application No. 2004-84751 filed on Oct. 22, 2004 in the Korean Intellectual Property Office, the entire disclosure of which is incorporated herein by reference.

### BACKGROUND OF THE INVENTION

1. Field of the Invention

The present invention generally relates to a method of preparing a toner composition. More particularly, the present invention relates to a method of preparing a toner composition from which a toner may be prepared by a simple process, increasing the fusing property and durability of the toner, wherein the toner is a dry-type prepared through emulsion polymerization.

2. Description of the Related Art

Although there are various imaging mechanisms, an electrophotographic imaging apparatus is generally used due to the need for high speed printing of an image, providing light to an apparatus, clearness of a final printed image, and the like. An electrophotographic imaging apparatus includes a facsimile, an LED (light-emitting diode), an LCS (liquid crystal shutter) printer, a digital printer, a laser printer or a laser copying machine, and the like. A developer or a toner of such an apparatus may be largely divided into a dry-type and a wet-type depending on an environment to be used. The dry-type toner is sub-divided into a pulverizing toner and a polymerizing toner.

A toner employing emulsion polymerization among the polymerizing toners generally forms a core by coagulating a binder resin, a colorant and a releasing agent present on a latex with a coagulant, and then performs a second coagulation and melting process, thus forming a shell outside the core to prepare final toner particles.

U.S. Pat. No. 6,120,967 discloses a method of preparing a toner in which a wax emulsion, a pigment dispersion and a latex resin are previously prepared, mixed, and coagulant is added to the mixture to coagulate the materials to prepare a toner.

U.S. Pat. No. 5,863,696 discloses a polymerizing method to form a polymer in which a pigment dispersion is prepared, and it is mixed with a polymerizable monomer to prepare a polymer comprising a pigment.

In a core/shell structure of a polymerizing toner according to the above patents or other conventional art, a low molecular weight binder resin is used in the core, and a high molecular weight binder resin is used in the shell to provide fusing and durability. However, when using a high molecular weight latex in the shell for durability, it is difficult to embody a shape as a toner during the melting process. To smooth the surface of toner particles for embodying a shape as a toner, a long melting time and a high melting temperature are required. Due to this, the production cost may be increased, and it is also difficult to form a shell having high durability.

Furthermore, for a toner not having the core/shell structure, when using a binder resin having low molecular weight for improving the fusing property, the durability may be reduced.

### SUMMARY OF THE INVENTION

Accordingly, an aspect of the present invention includes a method of preparing a toner composition that has core/shell structures, wherein the structures are prepared by an emulsion polymerization method, and wherein a toner composition having the smooth surfaces of particles while maintaining its high durability may be prepared in a non-complex process by forming a shell part through a polymerization reaction on the core surface.

The above aspect of the present invention is substantially realized by providing a method of preparing a toner composition including mixing a colorant dispersion and a latex solution and coagulating to form the core of the toner particle; adding a polymerization initiator to the core; and adding a monomer to the core to form a shell of the toner particle through polymerization on the core surface.

Generally, the Tg of the shell is higher than that of the core.

The latex solution is a mixed solution of a latex and a wax.

The latex may encapsulate the wax.

The continuous phase used in preparing the toner composition is ultra-pure water, wherein ultra-pure water is distilled water.

The monomer includes at least one monomer selected from the group consisting of styrene, methylstyrene, chlorostyrene, dichlorostyrene, p-tert-butylstyrene, p-n-butylstyrene, p-n-nonylstyrene, acrylate, methyl acrylate, ethyl acrylate, propyl acrylate, isobutyl acrylate, n-butyl acrylate, beta carboxy acrylate, hydroxyethyl acrylate, ethylhexyl acrylate, methacrylate, methyl methacrylate, ethyl methacrylate, propyl methacrylate, n-butyl methacrylate, isobutyl methacrylate, hydroxyethyl methacrylate, ethylhexyl methacrylate, acrylic acid, itaconic acid, methacrylic acid, maleic acid, fumaric acid, cinnamic acid, sulfonated styrene, aminostyrene and its quaternary ammonium salt, vinylpyridine, vinylpyrrolidone, acrylonitrile, butadiene, isoprene and divinylbenzene.

The wax includes at least one wax selected from the group consisting of carnauba wax, bayberry wax, bees wax, shellac wax, spermacetti wax, montanic wax, ozokerite wax, ceresin wax, paraffin wax, microcrystalline wax, Fischer-Tropsch wax, polyethylene wax, polypropylene wax, acrylate wax, fatty acid amide wax, silicon wax and polytetrafluoroethylene wax.

The colorant dispersion includes at least one colorant selected from the group consisting of azo-based pigment, phthalocyanin-based pigment, basic dye-based pigment, quinacridone-based pigment, dioxazine-based pigment, condensation azo-based pigment, carbon black, chromate, ferrocyanide, oxide, sulfate selenide, sulfate, silicate, carbonate, phosphate, and metal powder.

The core size of the toner particles may be within a range of 0.5 μm to 4 μm.

The size of the toner particles may be within a range of 1 μm to 10 μm.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flow chart illustrating a method in accordance with one embodiment of the present invention; and

FIG. 2 is a flow chart illustrating another embodiment of a method in accordance with the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

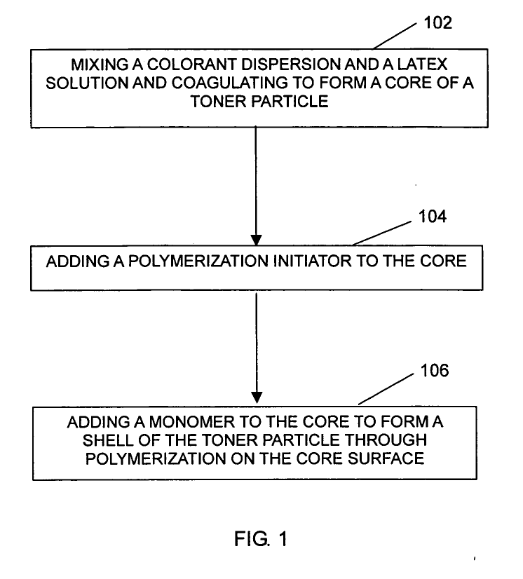

According to an embodiment of the present invention, when toner particles consist of core/shells, monomers are polymerized on the core surfaces to form a shell. As shown in FIG. 1, a method of preparing a toner composition in accordance with the present invention includes: mixing a colorant dispersion and a latex solution and coagulating to form a core of a toner particle 102; adding a polymerization initiator to the core 104; and adding a monomer to the core to form a shell of the toner particle through polymerization on the core surface 106.

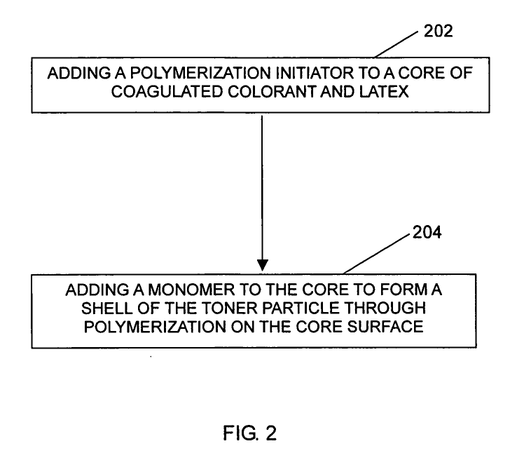

Alternatively, as shown in FIG. 2, in accordance with another embodiment of the present invention, the method includes: adding a polymerization initiator to a core of coagulated colorant and latex 202; and adding a monomer to the core to form a shell of the toner particle through polymerization on the core surface 204.

Colorant dispersion and latex are mixed and coagulated to form the cores of the toner particles.

A colorant embodies a color on a printed image and includes a dyestuff-based colorant, and a pigment-based colorant. The pigment-based colorant, which is superior in terms of heat stability and light resistance, may be typically used.

The colorant includes an azo-based pigment, a phthalocyanine-based pigment, a basic dye-based pigment, a quinacridone-based pigment, a dioxazine-based pigment, a condensation azo-based pigment, carbon black, chromate, ferrocyanide, oxide, sulfate selenide, sulfate, silicate, carbonate, phosphate, and metal powder. Among these, a single colorant may be used, or more than two pigments may be used in mixtures. However, the colorant, which may be used in the present invention is not limited to these.

The black pigment of the pigments, which may be used in the present invention, includes carbon black, and color pigments are as follows, according to their colors:

A blue and/or green pigment includes a copper phthalocyanine, a C.I.P.B. (C.I. pigment blue) 15, 15:1, 15:2, 15:3, 15:4, 15:6, 16 (nonmetal phthalocyanine), or a phthalocyanine having an aluminum, a nickel or a vanadium as a central metal, and a bridged phthalocyanin dimer/oligomer such as an Si—bridged phthalocyanin.

An orange pigment includes a P.O. 5, 13, 34, 36, 43, 62, 71, 72, or the like.

A yellow pigment includes a P.Y. 12, 17, 74, 83, 93, 97, 122, 146, 155, 174, 180, 185, or the like.

A red pigment includes a P.R. 48, 57, 122, 146, 147, 176, 184, 186, 202, 207, 238, 254, 255, 269, 270, 272, or the like.

A violet pigment includes a P.V. 1, 19, 23, or the like.

A mixed pigment includes a P.V.19/P.R.122 or P.R.146/147, or the like.

The colorant dispersion is prepared by dispersing the above-mentioned colorant on a continuous phase with a dispersant and a milling equipment. Ultra-pure water such as de-ionized water is used as the continuous phase.

The dispersant, which may be used in preparing the colorant dispersion, includes any surfactant selected from the group consisting of anionic surfactants such as sodium dodecyl sulfate, sodium dodecylbenzene sulfonate, sodium dodecylnaphthalene sulfate, dialkyl benzenealkyl, sulfate and sulfonate; cationic surfactants such as dialkyl benzenealkyl ammonium chloride, alkyl benzyl methyl ammonium chloride, alkyl benzyl dimethyl ammonium bromide, benzalkonium chloride, cetyl pyridinium bromide, dodecylbenzyl triethyl ammonium chloride, lauryl amine acetate, stearyl amine acetate, and lauryl trimethyl ammonium chloride; amphionic surfactants such as lauryl dimethylamineoxide; and nonionic surfactants such as polyvinyl alcohol, polyacrylic acid, metallose, methyl cellulose, ethyl cellulose, propyl cellulose, hydroxyethyl cellulose, carboxymethyl cellulose, tristyrylphenol ethoxylate phosphate ester, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, and dialkylphenoxy poly(ethyleneoxy) ethanol. These surfactants may be used alone, or in mixtures of two or more. However, the dispersant that may be used in the present invention is not limited to these.

A commercially available dispersant includes DOWFAX, TERGITOL and TRITON, which are manufactured by the DOW CHEMICAL COMPANY.

Milling equipment includes a ball mill, the DYNO mill, the EIGER MILL 250, or the DISPPERMAT. A pigment and a dispersant are added to ultra-pure water, and milled with a glass bead at about 2,000 rpm to about 10,000 rpm for about an hour to about 5 hours using the described milling equipment to prepare a colorant dispersion. The ultra-pure water is used, which is deoxygenated by bubbling with nitrogen gas.

The quantity of the colorant contained in a toner composition through a colorant dispersion is generally controlled so that it is within a range of about 1 phr to about 20 phr. When the quantity of the colorant is less than about 1 phr, the color is not sufficiently embodied in a printed image. When the quantity is more than about 20 phr, the dispersity may decrease.

The latex solution, which is synthesized by emulsion-polymerizing a monomer to form latex, and a wax, are used. The latex particle encapsulates the wax. The latex solution and the wax dispersion may be separately prepared, and then mixed.

The latex resin is used as a binder in a toner composition, and the wax is a representative material used as a releasing agent.

The latex resin may be prepared by emulsion polymerizing a wax and a monomer. The monomer may be a polymerizable monomer, and selected from the group consisting of styrene-based monomer such as styrene, a methylstyrene, chlorostyrene, dichlorostyrene, p-tert-butylstyrene, p-n-butylstyrene and p-n-nonylstyrene; (meth)acrylic acid ester-based monomer such as acrylate, methyl acrylate, ethyl acrylate, propyl acrylate, isobutyl acrylate, n-butyl acrylate, beta carboxy acrylate, hydroxyethyl acrylate, ethylhexyl acrylate, methacrylate, methyl methacrylate, ethyl methacrylate, propyl methacrylate, isobutyl methacrylate, n-butyl methacrylate, hydroxyethyl methacrylate and ethylhexyl methacrylate; monomer having a carboxyl group such as acrylic acid, itaconic acid, methacrylic acid, maleic acid, fumaric acid and cinnamic acid; monomer having a sulfonic acid group such as sulfonated styrene; aminostyrene and its quaternary ammonium salt; a monomer having an N-containing hetero ring such as vinylpyridine and vinylpyrollidone; acrylonitrile, butadiene, isoprene and divinylbenzene, or the like, and these monomers are used alone, or in mixtures of two or more. The monomers are not limited to these. Such a monomer and a wax are mixed together, and the mixture is melted at a temperature greater than the Tg of the monomer to prepare a latex resin solution in which the latex particles encapsulating the wax are dispersed.

Furthermore, a latex resin and a wax dispersion are used in a mixture. Herein, the latex resin includes poly(styrenebutadiene), poly(para-methyl styrenebutadiene), poly(meta-methyl styrenebutadiene), poly(ethylmethacrylate-butadiene), poly(propylmethacrylate butadiene), poly(butylmethacrylate-butadiene), poly(methylacrylate butadiene), poly(ethylacrylate butadiene), poly(propylacrylate butadiene), poly(butylacrylate butadiene), poly(styrene isoprene), poly(para-methyl styrene isoprene), poly(meta-methyl styrene isoprene), poly(alpha-methyl styrene isoprene), poly(methylmethacrylate isoprene), poly(ethylmethacrylate isoprene), poly(propylacrylate isoprene), poly(butylacrylate isoprene), poly(styrene butadiene acrylic acid), poly(styrene butadiene methacrylic acid), polyethyleneterephthalate, polypropyleneterephthalate, polybutyleneterephthalate, polypentyleneterephthalate, polyhexaleneterephthalate, polyheptadeneterephthalate, polyoctaleneterephthalate, or the like.

The releasing agent prevents toner offset by improving release properties between a roller and a toner when a toner image is transferred to a recording medium and fused thereon, and prevents the recording medium from sticking to the roller and being entangled therewith.

The wax may be any commercially available one. For example, a wax selected from a natural plant wax such as a carnauba wax and a bay-berry wax; a natural animal wax such as a bees wax, a shellac wax and a spermaceti wax; a mineral wax such as a montanic wax, an ozokerite wax and a ceresin wax; a petroleum wax such as a paraffin wax and a microcrystalline wax; and a synthetic wax such as the Fischer-Tropsch wax, a polyethylene wax, a polypropylene wax, an acrylate wax, a fatty acid amide wax, a silicon wax and a polytetrafluoroethylene wax may be used alone, or in mixtures of two or more. However, the wax that may be used in the present invention is not limited to these.

The quantity of the wax contained in a latex solution is generally within a range of about 1 phr to about 50 phr. When the quantity of the wax is less than about 1 phr, the wax does not function as a releasing agent. When the quantity is more than about 50 phr, the dispersity of the wax may be decreased.

The unit ‘phr’ is an abbreviation for part per hundreds of resin, and indicates mass unit of subject additive per 100 parts of a resin.

The colorant dispersion and the latex solution are mixed, and a coagulant is added to coagulate the mixture. The mixing may be performed by any general method used in mixing.

The coagulant, which has a counter charge to that of a surfactant added as a dispersant in the latex solution, is used to coagulate the materials. The quantity of a coagulant to be added is controlled in a sufficient amount to coagulate particles within a suitable range so that the coagulant may not influence to the properties of a toner. The coagulant may be an organic material or an inorganic material.

The coagulant that may be used in the present invention includes polyaluminum chloride, aluminum sulfate, zinc sulfate, magnesium sulfate, magnesium chloride, or the like. These may be used alone or in a mixture of two or more, or in a mixture with another coagulant.

After the latex particle and the colorant particle are coagulated by adding such a coagulant to form particles having the size of 0.5 μm to 4 μm, that is, core particles, the coagulated particles are melted by heating. The heating temperature is a temperature above the Tg of the core particles. The Tg of the core particles may be the Tg of the latex resin since the latex resin includes about more than 90% of the core particles. Generally, the heating is performed at a temperature of about 80° C. to 100° C. When the heating is performed at a temperature above the Tg of the core particles, each particle in the coagulated core particles is melted and bound. The time utilized for melting and binding is adjusted within a range of about 0.5 to about 2 hrs.

The core particles are thus formed, and a polymerization initiator is firstly added to the solution in which the core particles are dispersed.

The polymerization initiator that may be used in the present invention includes potassium persulfate, ammonium persulfate, benzoyl peroxide, lauryl peroxide, sodium persulfate, hydrogen peroxide, t-butyl hydroperoxide, cumene hydroperoxide, para-methane peroxide and peroxy carbonate, or the like; however, the initiator is not limited to these.

The polymerization initiator is added, and a monomer that is to perform polymerization on the core surface is added. A monomer that is to form a shell is selected from the group consisting of styrene, methylstyrene, chlorostyrene, dichlorostyrene, p-tert-butylstyrene, p-n-butylstyrene, p-n-nonylstyrene, acrylate, methyl acrylate, ethyl acrylate, propyl acrylate, isobutyl acrylate, n-butyl acrylate, beta carboxy acrylate, hydroxyethyl acrylate, ethylhexyl acrylate, methacrylate, methyl methacrylate, ethyl methacrylate, propyl methacrylate, n-butyl methacrylate, isobutyl methacrylate, hydroxyethyl methacrylate, ethylhexyl methacrylate, acrylic acid, itaconic acid, methacrylic acid, maleic acid, fumaric acid, cinnamic acid, sulfonated styrene, aminostyrene and its quaternary ammonium salt, vinylpyridine, vinylpyrrolidone, acrylonitrile, butadiene, isoprene and divinylbenzene. When choosing a monomer, it is chosen so that the Tg may be set at a predetermined level on mixing the monomer to polymerize.

A polymerization toner having the core/shell structure requires that the Tg of the shell is higher than that of the core for the fusing property and durability of the toner. For the Tg of the shell that is higher than that of the core, a resin having a high molecular weight is typically used. Although the resin having the high molecular weight has difficulty in embodying a shape as a toner during melting process, a shape as a toner is easily embodied when the resin has a high molecular weight through surface polymerization, as in the present invention.

The selected monomer or monomer mixtures are slowly added to a solution in which a core is dispersed. This monomer or monomer mixtures perform surface polymerization while forming a shell layer on the core surface. Agitation is performed so that the agitation speed may be within about 100 rpm to about 800 rpm. Polymerization is performed maintaining a temperature within a range of 50° C. to 90° C. Polymerization time may be within about 2 hrs to about 10 hrs. After a proper reaction time lapses, spontaneous cooling is performed at room temperature.

The shell thus formed has a higher Tg and a higher molecular weight than those of the core by the monomer composition ratio, and thus toner particles having excellent durability may be generated. The Tg used herein refers to a glass transition temperature.

The Tg of a polymer may be calculated using a value known for a high molecular homopolymer and a fox equation represented by equation 1 below. The fox equation is described in A. W. Wicks, F. N. Johnes & S. P. Pappa, Organic coatings, 1, John Wiley, New York, pp. 54-55 (1992). In the equation i below, wi is a weight fraction of the monomer “i”, and Tgi is a glass transition temperature of the high molecular weight homopolymer made of the monomer “i”.

$$\frac{1}{Tg} = \frac{w1}{Tg1} + \frac{w2}{Tg2} \qquad Equation 1$$

Using equation 1, the glass transition temperature of an organosol core may be controlled to a desired temperature with the glass transition temperature of a polymerizable monomer and its weight fraction. That is, the glass transition temperatures of the core and the shell are set to desired temperatures, the monomer “1” and the monomer “2” to be used in polymerization are determined to set the glass transition temperatures, and the weight fraction of the monomer “1” and the monomer “2” to be used may be determined using equation 1. The glass transition temperature of a sample of homopolymer made of a polymerizable monomer is, for example, as follows.

TABLE 1

| Monomer | Tg (° C.) |
|---|---|
| t-butyl methacrylate | 107 |
| n-butyl methacrylate | 20 |
| n-butyl acrylate | −55 |
| ethyl acrylate | −24 |
| methyl acrylate | 105 |
| ethyl methacrylate | 66 |
| lauryl methacrylate | −65 |

The final particle size of the toner particles prepared as described above may be within a range of 1 μm to 10 μm. The size of the toner particle influences to clearness of the final printed image. The smaller the size of the toner particle is, the clearer the final printed image is. However, when the size of the toner particle is too small, it may become difficult to control electrically the toner particles. Thus, the size of the toner particle is generally controlled within the range described above.

Hereinafter, the present invention will be described in more detail with reference to the examples according to the present invention.

### EXAMPLE 1

Preparation of the Cores of Toner Particles

A pigment dispersion was prepared by milling 30 g of P.B. 15:3, 100 g of ultra-pure water and 10 g of DOWFAX 2A-1 along with 200 g of glass beads with using DISPERSMAT in a speed of about 3000 rpm for an hour.

100 g of a monomer mixture in which styrene, butyl acrylate and acrylic acid are mixed in a ratio of approximately 7:2:1, and about 1% by weight of a 1-dodecanethiol as a chain transfer agent based on 100% by weight of the total latex solution, and about 10% by weight of an ester wax based on 100% by weight of the total latex solution were mixed with heating to prepare a latex containing the wax.

Next, 50 g of the pigment dispersion prepared above and 900 g of the wax-containing latex solution were mixed with 1500 ml of ultra-pure water in which 6 g of DOWFAX 2A-1 were dissolved. To this solution, a solution in which 15 g of a polyaluminum chloride as a coagulant were diluted in 40 g of ultra-pure water, were slowly dropped with a dropping funnel. The reaction bath was heated for about 30 minutes at a temperature above the Tg of the latex by increasing slowly the temperature of the reaction bath. Next, the particles were melted by heating to 95° C. The RPM of the reaction impeller at this time was about 200 rpm, and the melting time was about 2 hours. The size of the coagulated core thus prepared was 3.5 μm.

Preparation of Toner Particles

The temperature of the solution in which the core prepared as described above was dispersed was cooled down to 70° C. A solution that included 1 g of potassium persulfate as a polymerization initiator was diluted in 40 g of ultra-pure water, was added as a reaction solution with a dropping funnel.

Styrene, butyl acrylate and acrylic acid were mixed in a ratio of about 7.5:1:0.5, and the mixture were added to the reaction solution over about 30 minutes with a dropping funnel. The RPM of the reaction bath at this time was controlled to be about 500 rpm.

Next, the reaction solution was subjected to polymerization for about 2 hours, and cooled down spontaneously to prepare a solution in which toner particles are dispersed.

Filtering the solution and washing were performed by an external adding process, and the resulting product was dried in a vacuum oven.

The volume average size of the toner particles thus prepared, in which their surfaces are polymerized, was 5 μm.

A toner composition was prepared through external addition to the toner particles.

### EXAMPLE 2

A toner composition was prepared according to the same manner as in the example 1, except that the core of the toner particle was prepared by using the mixture of 750 g of a latex and 150 g of an ester wax emulsion instead of using 900 g of the wax-containing latex.

### EXAMPLE 3

A toner composition was prepared according to the same manner as in the example 1, except that a magnesium chloride was used instead of using the polyaluminum chloride as a coagulant.

### EXAMPLE 4

A toner composition was prepared according to the same manner as in the example 1, except that the core of the toner particle was prepared by using the mixture of 750 g of a latex and 150 g of a carnauba/polyethylene mixed wax emulsion instead of using 900 g of the wax-containing latex.

### EXAMPLE 5

A toner composition was prepared according to the same manner as in the example 1, except that P.Y.180 was used instead of using the P.B.15:3.

### EXAMPLE 6

A toner composition was prepared according to the same manner as in the example 1, except that P.R.122 was used instead of using the P.B.15:3.

### EXAMPLE 7

A toner composition was prepared according to the same manner as in the example 1, except that a carbon black (NIPEX 70) was used instead of using the P.B.15:3.

### EXAMPLE 8

A toner composition was prepared according to the same manner as in the example 1, except that a methyl acrylic acid was used instead of using the acrylic acid.

### EXAMPLE 9

A toner composition was prepared according to the same manner as in the example 1, except that 4 g of a sodium dodecyl sulfate were used instead of using 10 g of the DOWFAX 2A-1.

According to embodiments of the present invention described above, by forming a shell through polymerization reaction on the core surface in toner particles having core/shell structures, a toner composition by which the shape of a toner may be embodied even with high durability, may be prepared. Furthermore, the particles that are not easily melted may also have smooth surface by polymerization reaction, processes map be shortened and costs may be reduced. By including a wax and a colorant in the core portion of a toner, a toner in which its particle size distribution is narrow, and the binding level among particles of a wax, a colorant and a latex is improved, may be provided.

The foregoing embodiment and advantages are merely exemplary and are not to be construed as limiting the present invention. The present teaching may be readily applied to other types of apparatuses. Also, the description of the embodiments of the present invention is intended to be illustrative, and not to limit the scope of the claims, and many alternatives, modifications, and variations will be apparent to those skilled in the art. Thus, although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of preparing a toner composition, comprising:
mixing a colorant dispersion and a latex solution and coagulating to form a core of a toner particle;
adding a polymerization initiator to the core; and
adding a monomer to the core to form a shell of the toner particle through polymerization on the core surface.

2. The method as claimed in claim 1, wherein a Tg of the shell is greater than a Tg of the core.

3. The method as claimed in claim 1, wherein the latex solution is a mixed solution of a latex and a wax.

4. The method as claimed in claim 3, wherein the latex encapsulates the wax.

5. The method as claimed in claim 1, wherein the colorant dispersion is prepared by dispersing a colorant on a continuous phase of ultra-pure water.

6. The method as claimed in claim 1, wherein the monomer comprises at least one monomer selected from the group consisting of styrene, methylstyrene, chlorostyrene, dichlorostyrene, p-tert-butylstyrene, p-n-butylstyrene, p-n-nonylstyrene, acrylate, methyl acrylate, ethyl acrylate, propyl acrylate, isobutyl acrylate, n-butyl acrylate, beta carboxy acrylate, hydroxyethyl acrylate, ethylhexyl acrylate, methacrylate, methyl methacrylate, ethyl methacrylate, propyl methacrylate, n-butyl methacrylate, isobutyl methacrylate, hydroxyethyl methacrylate, ethylhexyl methacrylate, acrylic acid, itaconic acid, methacrylic acid, maleic acid, fumaric acid, cinnamic acid, sulfonated styrene, aminostyrene and its quaternary ammonium salt, vinylpyridine, vinylpyrrolidone, acrylonitrile, butadiene, isoprene and divinylbenzene.

7. The method as claimed in claim 3, wherein the wax comprises at least one wax selected from the group consisting of carnauba wax, bayberry wax, bees wax, shellac wax, spermaceti wax, montanic wax, ozokerite wax, ceresin wax, paraffin wax, microcrystalline wax, Fischer-Tropsch wax, polyethylene wax, polypropylene wax, acrylate wax, fatty acid amide wax, silicon wax and polytetrafluoroethylene wax.

8. The method as claimed in claim 1, wherein the colorant dispersion comprises at least one colorant selected from the group consisting of azo-based pigments, phthalocyanine-based pigments, basic dye-based pigments, quinacridone-based pigments, dioxazine-based pigments and condensation azo-based pigments, carbon black, chromate, ferrocyanide, oxide, sulfate selenide, sulfate, silicate, carbonate, phosphate, and metal powder.

9. The method as claimed in claim 1, wherein the core size of the toner particle is within a range of about 0.5 μm to about 4 μm.

10. The method as claimed in claim 1, wherein the size of the toner particle is within a range of about 1 μm to about 10 μm.

11. A method of preparing a coated toner composition on a coaggulated core, comprising:
adding a polymerization initiator to the coagulated core; and
adding a monomer to the coaggulated core to form a shell of the toner particle through polymerization on a surface of the coaggulated core.

12. The method of claim 11, wherein adding the monomer to the coaggulated core is performed prior to adding the polymerization initiator to the coaggulated core.

13. The method as claimed in claim 11, wherein a Tg of the shell is greater than a Tg of the coaggulated core.

14. The method as claimed in claim 11, wherein the latex further includes a wax.

15. The method as claimed in claim 14, wherein the latex encapsulates the wax.

16. The method as claimed in claim 11, wherein the coaggulated core is prepared by dispersing a colorant on a continuous phase of ultra-pure water and mixing the colorant dispersion with a latex solution.

17. The method as claimed in claim 11, wherein the monomer comprises at least one monomer selected from the group consisting of styrene, methylstyrene, chlorostyrene, dichlorostyrene, p-tert-butylstyrene, p-n-butylstyrene, p-n-nonylstyrene, acrylate, methyl acrylate, ethyl acrylate, propyl acrylate, isobutyl acrylate, n-butyl acrylate, beta carboxy acrylate, hydroxyethyl acrylate, ethylhexyl acrylate, methacrylate, methyl methacrylate, ethyl methacrylate, propyl methacrylate, n-butyl methacrylate, isobutyl methacrylate, hydroxyethyl methacrylate, ethylhexyl methacrylate, acrylic acid, itaconic acid, methacrylic acid, maleic acid, fumaric acid, cinnamic acid, sulfonated styrene, aminostyrene and its quaternary ammonium salt, vinylpyridine, vinylpyrrolidone, acrylonitrile, butadiene, isoprene and divinylbenzene.

18. The method as claimed in claim 14, wherein the wax comprises at least one wax selected from the group consisting of carnauba wax, bayberry wax, bees wax, shellac wax, spermaceti wax, montanic wax, ozokerite wax, ceresin wax, paraffin wax, microcrystalline wax, Fischer-Tropsch wax, polyethylene wax, polypropylene wax, acrylate wax, fatty acid amide wax, silicon wax and polytetrafluoroethylene wax.

19. The method as claimed in claim 11, wherein the colorant comprises at least one colorant selected from the group consisting of azo-based pigment, phthalocyanine-based pigment, basic dye-based pigment, quinacridone-based pigment, dioxazine-based pigment and condensation azo-based pigment, carbon black, chromate, ferrocyanide, oxide, sulfate selenide, sulfate, silicate, carbonate, phosphate, and metal powder.

20. The method as claimed in claim 11, wherein the coaggulated core size of the toner particle is within a range of about 0.5 μm to about 4 μm.

21. The method as claimed in claim 11, wherein the size of the toner particle is within a range of about 1 μm to about 10 μm.
